(19) United States
(12) Patent Application Publication
(10) Pub. No.: US 2025/0383986 A1
(43) Pub. Date: Dec. 18, 2025

(54) Garbage Collection with Isolation of Data Placed According to Flexible Data Placement by Different Reclaim Unit Handles

(71) Applicant: Micron Technology, Inc., Boise, ID (US)

(72) Inventor: Luca Bert, Bologna (BO) (IT)

(21) Appl. No.: 19/179,549

(22) Filed: Apr. 15, 2025

Related U.S. Application Data
(60) Provisional application No. 63/650,571, filed on May 22, 2024.

(51) Int. Cl. G06F 12/02

(52) U.S. Cl. CPC G06F 12/0253

(57) ABSTRACT

A memory sub-system configured to: execute write commands received from outside of the memory sub-system according to their data placement directives to separate data of the write commands into data sets stored in first reclaim units in the memory sub-system such that each of the first reclaim units stores data for no more than one of the data sets; reserve a second reclaim unit handle for garbage collection; identify, during garbage collection and from the first reclaim units, first victim reclaim units having first residual data that remains valid in the first victim reclaim units, the first residual data having portions from different ones of the data sets; and write, using the second reclaim unit handle, the first residual data to second reclaim units, each of the second reclaim units storing data for no more than one of the data sets.

### RELATED APPLICATIONS

The present application claims priority to Prov. U.S. Pat. App. Ser. No. 63/650,571 filed May 22, 2024, the entire disclosures of which application are hereby incorporated herein by reference.

### TECHNICAL FIELD

At least some embodiments disclosed herein relate to memory systems in general, and more particularly, but not limited to memory systems configured to support flexible direct placement (FDP).

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Flexible direct placement (FDP) is a recently developed technology for a host system to write data into a memory sub-system. When a communication protocol supporting flexible direct placement is used, the host system can specify a data placement directive in a write command sent from the host system to the memory sub-system. The data placement directive instructs the memory sub-system to write data into a reclaim unit having a set of memory cells that are configured to be erased together.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 illustrates the use of a reclaim unit handle to store data during garbage collection of data placed by other reclaim unit handles according to one embodiment.

FIG. 3 shows the configuration of reclaim unit handles to implement garbage collection according to one embodiment.

FIG. 4 to FIG. 6 show techniques to isolate data placed by different reclaim unit handles according to some embodiments.

FIG. 7 shows a method of garbage collection according to one embodiment.

FIG. 8 is a block diagram of an example computer system in which embodiments of the present disclosure can operate.

### DETAILED DESCRIPTION

At least some aspects of the present disclosure are directed to the isolation of data copied during garbage collection operations in a memory sub-system (e.g., a data storage device, such as a solid-state drive).

A conventional memory sub-system can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

When a block of memory cells has some pages that can be erased and other pages that have valid data, the memory sub-system can perform the operation of garbage collection in which the valid data is copied from the block and written to outside of the block. After the valid data is copied to outside of the block, the entire block can be erased to reclaim the storage resources of the block without data loss. However, copying the valid data from a block for the purpose of erasing the block (so that the previously programmed pages in the block can be again programmed to store new data) increases the activities of programming memory cells to write data and thus leads to increased write amplification (e.g., the ratio between the amount of data being programmed to preserve host data in the storage media of the memory sub-system and the amount of the host data being preserved). Increased write amplification can reduce the performance of the memory sub-system and/or the useful life of the memory cells in the memory sub-system.

A conventional host system is configured to instruct a memory sub-system to store data at locations specified via logical addresses. The memory sub-system can have a flash translation layer configured to map the logical addresses as known to the host system to physical addresses of memory cells in the memory sub-system. As a result, the host system may not be aware which data items are stored in a block having pages configured to be erased together and thus may have fewer options in assisting the reduction of garbage collection and/or write amplification in the memory sub-system.

Flexible direct placement (FDP) is a recently developed technology that supports a communication protocol between a host system and a memory sub-system. With flexible direct placement (FDP), the host system can be aware of which data items are stored together in a unit of memory cells that are configured to be erased together during reclaiming storage resources in the memory sub-system. Such a unit can be referred to as a reclaim unit (RU) (e.g., as in flexible direct placement (FDP)).

For example, flexible direct placement (FDP) (or similar technologies) allows a host system to specify on which reclaim unit handle (RUH) data should be placed by a memory sub-system. Thus, a host system can provide data placement directives, according to a protocol of flexible direct placement (FDP), with write commands to cause the memory sub-system to store different sets of data into different sets of reclaim units.

During garbage collection small chunks of residual data can be found remaining valid in some reclaim units. To erase such reclaim units and thus reclaim the storage resources of the reclaim units, such small chunks of residual data are to be copied and collected from the reclaim units to other reclaim units. When the small chunks of residual data are being collected from different data sets, it can be a challenge to maintain data separate and implement garbage collection efficiently.

At least some aspects of the present disclosure address the above and other deficiencies and challenges by configuring a reclaim unit handle in a memory sub-system to store residual data collected during garbage collection. The reclaim unit handle can aggregate residual data collected from a same data set for storing in one or more reclaim units that do not store data collected from other data sets. Residual data collected from different data sets are stored into different sets of reclaim units. As a result, data isolation across the different data sets can be maintained with reduced or minimized resources allocation for garbage collection.

For example, initial isolation of data sets can be achieved via a host system using different reclaim unit handles in data placement directives of write commands sent from the host system to write data of different data sets to the memory sub-system. Each reclaim unit handle used by the host system in writing data can have a set of reclaim units separate from other reclaim units allocated to other reclaim unit handles. Thus, before garbage collection, different data sets written by the host system using the different reclaim unit handles are physically separated for storing into the different sets of claim units allocated to the respective reclaim unit handles. A same reclaim unit does not store data directed by the host to be placed via the use of more than one reclaim unit handle.

During garbage collection a reclaim unit handle can be allocated to store residual data collected from the different sets of reclaim units allocated to the different reclaim unit handles for different data sets. The reclaim unit handle allocated to the garbage collection can aggregate residual data collected from reclaim units storing a same data set for storing in one or more reclaim units, before storing residual data collected from other data set into other reclaim units. Such a technique can reduce the number of reclaim units allocated for garbage collection and can maintain data isolation for the different data sets. Initial isolation of data sets implemented via the host system using the different reclaim unit handles to write data of different data sets can persist after garbage collection.

In some instances, the workload of storing residual data for different data sets during garbage collection can be heavy and fragmented. To avoid delay and excessive resource usages, the reclaim unit handle allocated for garbage collection can be configured to temporarily mix residual data from different data sets into a same reclaim unit. Optionally, the reclaim unit handle can further store additional data to identify the origins of the residual data being mixed into a reclaim unit. Subsequently, the memory sub-system can restore the mixed residual data for data aggregation and separation according to data sets as identified by the additional data. Restoring the mixed residual data (e.g., in combination with a next garbage collection operation) can restore data isolation across the data sets such that no reclaim unit stores data from different data sets.

For example, the memory sub-system can have N reclaim unit handles that are exposed to, and thus usable by, the host system. The host system can write the data of N different sets using the N different reclaim unit handles respectively, such that the N different sets of data are stored separately into N different sets of reclaim units allocated to the N reclaim unit handles respectively.

It is possible to use N internal reclaim unit handles to perform garbage collection for the N exposed reclaim unit handles respectively in order to maintain data isolation for the N sets of data. However, such an approach allocates too much resources to garbage collection and can degrade the overall performance of the memory sub-system. Instead, a single garbage collection reclaim unit handle can be configured for garbage collection to store residual data collected from the N sets of the reclaim units used by the N reclaim unit handles respectively.

For example, garbage collection for the N different sets of reclaim units allocated to the N reclaim unit handles respectively can be performed sequentially. During garbage collection performed for one of N reclaim unit sets, the residual data collected is known to be for a same data set and can be stored to one or more reclaim units for the erasure of reclaim units in the reclaim unit set that is the current target of garbage collection. Upon completion of garbage collection for the current reclaim unit set for one data set, the garbage collection for the next reclaim unit set for another data set can start to store collected residual data into one or more reclaim units allocated separately for the garbage collection for the next reclaim unit set. Thus, the number of reclaim units reserved for garbage collection can be reduced or minimized.

Using one reclaim unit handle for garbage collection can result in a longer time to complete garbage collection, when compared to the use of N reclaim unit handles to target the N sets of reclaim units in parallel for garbage collection. In anticipation of the longer timer of garbage collection, the onset of garbage collection can be configured to start earlier to reduce or minimize the performance impact caused by the extended operation time of garbage collection.

When there is a storm of requests to store residual data collected from different data sets, the memory sub-system can optionally mix and store the residual from different sets into a same reclaim unit for improved performance. Such situations can be rare and thus tolerated. When data collected from different data sets during garbage collection is stored in a same reclaim unit, the memory sub-system can raise a flag to indicate a change from persistent isolation to initial isolation. As the mixed residual data becomes invalidated in the reclaim unit, the data sets can become fully isolated again; and the flag can be adjusted to indicate a change from initial isolation to persistent isolation.

Optionally, when residual data collected from different data sets is stored into a same reclaim unit, the memory sub-system can be further configured to store tags or references configured to identify the data sets from which corresponding portions of the residual data are collected.

For example, a reference can be stored to indicate that “what is stored from this point on is data from reclaim unit handle X”; and the portion of the residual data copied from a reclaim unit allocated to the reclaim unit handle X can be stored following the reference. Following the portion of the residual data from reclaim unit handle X, a next reference can be stored to indicate that “what is stored from this point on is data from reclaim unit handle Y”; and a next portion of the residual data copied from a reclaim unit allocated to the he reclaim unit handle Y can be stored following the next reference. Since such references or tags are small and easy to insert, their storages in the reclaim unit are generally few and apart such that they have negligible impact on storage capacity and garbage collection performance. Once the origins of the portions of the residual data collected from different data sets are tagged, the residual data mixed in the reclaim unit can be collected and aggregated with other data according to their data set origins for separation (e.g., during a next operation of garbage collection). Thus, the mode of storage of the data sets in the memory sub-system can be restored back to persistent isolation.

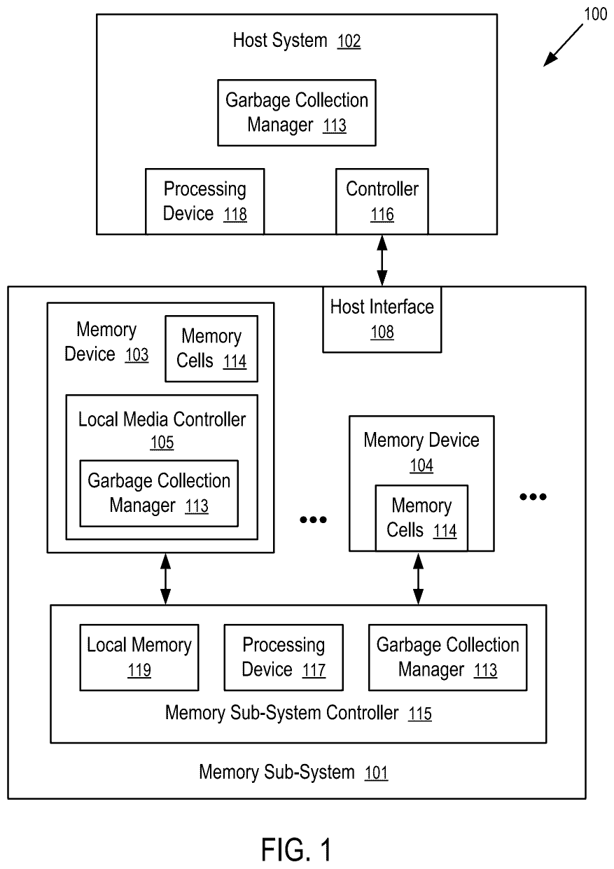

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a garbage collection manager 113 configured to perform operations related to garbage collection in the memory sub-system 101. In some embodiments, the controller 115 in the memory sub-system 101 includes at least a portion of the garbage collection manager 113. In other embodiments, or in combination, the controller 116 and/or the processing device 118 in the host system 102 includes at least a portion of the garbage collection manager 113. For example, the controller 115, the controller 116, and/or the processing device 118 can include logic circuitry implementing the garbage collection manager 113. For example, the controller 115, or the processing device 118 (processor) of the host system 102, can be configured to execute instructions stored in memory for performing the operations of the garbage collection manager 113 described herein. In some embodiments, the garbage collection manager 113 is implemented in an integrated circuit chip disposed in the memory sub-system 101. In other embodiments, the garbage collection manager 113 can be part of firmware of the memory sub-system 101, an operating system of the host system 102, a device driver, or an application, or any combination therein.

For example, the garbage collection manager 113 implemented in the computing system 100 can be configured to use a single reclaim unit handle to write residual data collected from reclaim units to be erased in a way implementing a best effort isolation of data sets. For example, residual data from reclaim units storing a same data set, isolated from other data sets, can be aggregated and written to a reclaim unit to avoid mixing data from different data sets into the reclaim unit. When it is inefficient to separate residual data of different data sets into different reclaim units, the garbage collection manger 113 can store into a reclaim unit not only the residual data collected from different data sets, but also identification data identifying the identity of the data sets from which portions of the residual data are collected. The placement of the residual data from more than one data set in the reclaim unit represents at least on isolation violation for the data sets. Thus, the memory sub-system 101 can raise a flag to indicate the occurrence of a violation, where data from different data sets is mixed in a reclaim unit. Optionally, the garbage collection manager 113 in the host system 102 can request the separation of data into different reclaim units, or request the data from the reclaim units for accelerated use and expiration of the data in the reclaim unit having isolation violations. Alternatively, during the next garbage collection operations, the garbage collection manager 113 can retrieve data from the reclaim unit having isolation violations and aggregate the retrieved data with newly collected residual data according to data sets. The aggregated data can be written into separate reclaim units to allow the corresponding data retrieved from the reclaim unit having isolation violations to be marked as invalid, which can reduce or eliminated isolation violations.

Further details of the operations of the garbage collection managers 113 in the host system 102 and in the memory sub-system 101 are discussed below.

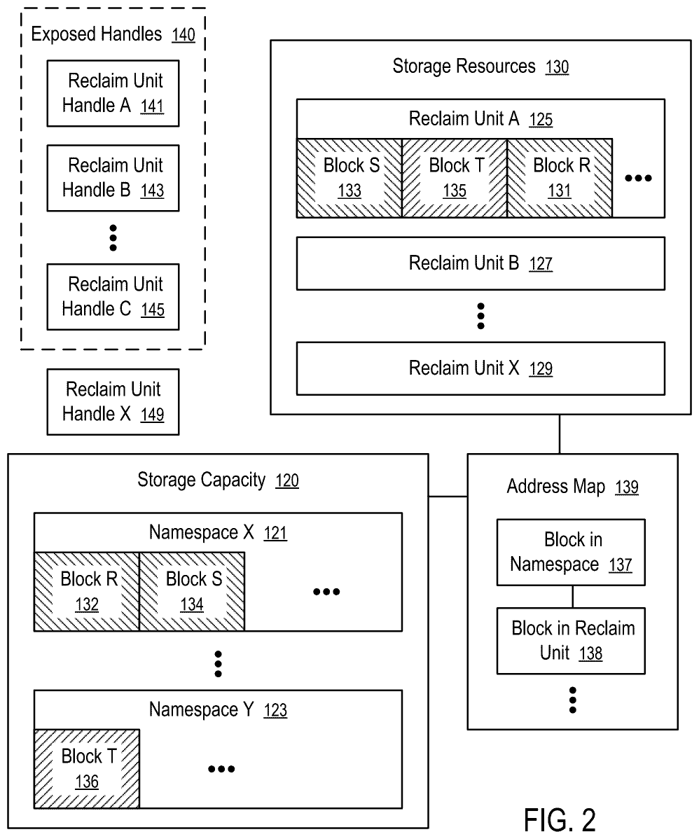

FIG. 2 illustrates the use of a reclaim unit handle to store data during garbage collection of data placed by other reclaim unit handles according to one embodiment. For example, the technique of FIG. 2 can be implemented in the computing system of FIG. 1 via the garbage collection managers 113.

In FIG. 2, a memory sub-system 101 (e.g., as shown in FIG. 1) maintains an address map 139 that is configured to identify the mapping between logical blocks (e.g., 137) defined in namespaces (e.g., 121, . . . , or 123) and physical blocks (e.g., 138) of storage resources (e.g., memory cells) that are currently allocated as storage media to store the data of the logical blocks (e.g., 137).

The memory sub-system 101 has a storage capacity 120 (e.g., storage capability provided by memory cells 114 in the memory devices 103, . . . , 104 in the memory sub-system 101 illustrated in FIG. 1). Different portions of the storage capacity 120 can be allocated to different namespaces (e.g., 121, . . . , 123). Within each namespace (e.g., 121 or 123), logical block addresses can be defined sequentially, starting from zero. The namespaces (e.g., 121, . . . , 123) and the logical block addresses defined in the namespaces (e.g., 121, . . . , 123) allow a host system 102 (e.g., as in FIG. 1) to specify the location of writing a block of data into the memory sub-system 101 or reading the block of data.

The memory sub-system 101 has physical storage resources (e.g., memory cells 114 in the memory devices 103, . . . , 104 in the memory sub-system 101 illustrated in FIG. 1). For example, the memory cells 114 in the memory sub-system 101 can be physically structured in pages of memory cells, blocks of pages, and planes of blocks.

The memory sub-system 101 can organize or group of storage resources (e.g., blocks of memory cells) into a reclaim unit (e.g., 125, 127, . . . , or 129) such that the memory cells in a reclaim unit can be erased together, before the storage resources can be programmed again to store new data. For example, the memory cells in each reclaim unit (e.g., 125, 127, . . . , or 129) can be erased without erasing any memory cells outside of the reclaim unit (e.g., 125, 127, . . . , or 129).

To store a block of data at a logical block address (e.g., corresponding to block 134 defined in the namespace 121), the memory sub-system 101 can allocate a block 133 of storage resources in the reclaim unit 125 as the media for the logical block 134. For example, the block 133 of storage resources can be one or more pages of memory cells allocated from one or more blocks of pages. In a typical implementation, the data size of the block 132 in the namespace 121 (e.g., identify via a logical block address defined in the namespace 121) is smaller than the storage capacity of a block of pages that are structured/wired to be erased together. Thus, the block 133 of storage resource in the reclaim unit 125 is not necessarily an entire block of pages.

The data of the logical block 132 in the namespace 121 can be stored in the media/storage resources in the block 133 of the reclaim unit 125. For example, to store the data, one or more pages of memory cells allocated as the block 133 of storage resources 130 can be programmed to have states (e.g., threshold voltage levels) that represent the data stored in the memory cells. The block of data can be retrieved from the media via a read command identifying the logical block address of the block 134 in the namespace 121. For example, the states (e.g., threshold voltage levels) that represent the data stored in the memory cells can be examined in a read operation to determine the data stored in the memory cells.

Instead of using a predetermined relation between the block 134 in the namespace 121 and the block 133 in the reclaim unit 125, the memory sub-system 101 maintains the address map 139 to indicate that the media of the block 134 in the namespace 121 is the block 133 in the storage resources 130. Using the address map 139, the memory sub-system 101 can translate (e.g., via a flash translation layer of the memory sub-system 101) the logical block address of the block 134 in the namespace 121 to the physical address of the block 133 in the storage resources 130.

In one implementation, the memory sub-system 101 supports flexible direct placement (FDP). Using a communication protocol supporting flexible direct placement (FDP), the host system 102 can write blocks (e.g., 134, 136) of different namespaces (e.g., 121, 123) into a same reclaim unit (e.g., 125). Further, the host system 102 can write blocks of a namespace (e.g., 121 or 123) into a reclaim unit (e.g., 125) in a random order, instead of sequentially.

The memory sub-system 101 has a degree of flexibility in allocating blocks of storage resources (e.g., memory cells) to a reclaim unit (e.g., 125). For example, the blocks (e.g., 131, 133, 135) of storage resources do not have to be a contiguous section of memory cells on an integrated circuit die. The blocks (e.g., 131, 133, 135) of storage resources can be allocated from different planes and/or integrated circuit dies. However, the blocks of storage resources allocated to each reclaim unit (e.g., 125) are such that the reclaim unit (e.g., 125) is erasable without erasing any storage resources outside of the reclaim unit (e.g., 125).

Using a protocol supporting flexible direct placement (FDP), the host system 102 can specify a data placement directive in a write command to request the use of a reclaim unit handle (e.g., 141) operating on the reclaim unit 125 to store data provided by the host system 102. With the data placement directive, the host system 102 can write to the block 134 in the namespace 121, causing the block 133 in the reclaim unit 125 to be used as the media for the block 134 and thus mapped accordingly in the address map 139. For example, in the address map 139, block 137 can identify block 134 in the namespace 121; and the associated block 138 can identify the physical block 133 in the reclaim unit 125 as the media of the logical block 134 in the namespace.

Subsequently, the host system 102 can use the same reclaim unit handle (e.g., 141) to write to the block 136 in a different namespace 123, causing the subsequent block 135 in the reclaim unit 125 to be used as the media for the block 136 in the namespace 123. Since the host system 102 uses the same reclaim unit handle (e.g., 141) to write the block 134 in the namespace 121 and the block 136 in the namespace 123, the host system 102 knows that the blocks 134 and 136 are stored into the same reclaim unit 125. For example, when the host system 102 determines that the blocks 134 and 136 have likewise life, the host system 102 can use the same reclaim unit handle to place their data together in a same reclaim unit 125.

Subsequently, the host system 102 can further use the same reclaim unit handle (e.g., 141) to write to the block 132 in the namespace 121, causing the block 131 in the reclaim unit 125 to be used as the media for the block 132. Thus, the reclaim unit 125 can host data of different namespaces (e.g., 121, 123) in a random order.

The memory sub-system 101 can expose a plurality of reclaim unit handles 141, 143, . . . , 145 to the host system 102. Using the exposed handles 140 (e.g., reclaim unit handles 141, 143, . . . , 145), the host system 102 can direct the memory sub-system 101 to place data of different data sets into different sets of reclaim units to implement physical isolation of data such that no data from different sets is stored into a same reclaim unit. For example, write commands to store data of one data set can be configured to identify a same reclaim unit handle (e.g., 141) such that the data stored via the write commands are programmed into a set of reclaim units allocated to the reclaim unit handle (e.g., 141) identified in the write commands; and write commands to store data of another data set can be configured to identify another same reclaim unit handle (e.g., 143) such that the data is stored into another of reclaim units allocated to the reclaim unit handle (e.g., 143) in the write commands. There is no overlapping in allocating reclaim units to different exposed handles 140. Thus, data written via the use of the exposed handles 140 is separated into being placed into different sets of reclaim units allocated to the respective reclaim unit handles 141, 143, . . . , 145.

For the purpose of data placement isolation, each data set to be isolated from other data sets can be identified based on the identification of a same reclaim unit handle (e.g., 141) specified in write commands from the host system 102 to write the corresponding data to the memory sub-system 101. The collection of data placed/written via each reclaim unit handle (e.g., 141) in the expose handles 140 can be recognized as a data set of the reclaim unit handle (e.g., 141) to be isolated in placement from other data sets of other reclaim unit handles (e.g., 143, or 145) among the exposed handles 140.

Without garbage collection the initial isolation of data as instructed via the use of the exposed handles 140 can persist in the memory sub-system without violation.

When the number of free reclaim units is low, and the previously programmed reclaim units to store the different data sets have a large amount of invalid data that can be erased, the memory sub-system 101 can start the operation of garbage collection. During garbage collection, the memory sub-system 101 can collect residual data that remains valid in selected victim reclaim units, and relocate their placement from the victim reclaim units to one or more free reclaim units. After the placement relocation, the victim reclaim units can be erased to free up the storage resources occupied by the invalid data in the victim reclaim units. The number of victim reclaim units that can be erased is larger than the reclaim units allocated to store the collected residual data. Thus, garbage collection can increase the number of available, free reclaim units in the memory sub-system 101.

In FIG. 2, a reclaim unit handle 149 is configured to perform the operations to write the residual data collected during garbage collection. Further, the reclaim unit handle 149 is configured to implement a best effort to avoid combining residual data from different data sets of the exposed handles 140 into a same reclaim unit and thus to maintain data placement isolation for the data sets of the exposed handles 140, as further discussed below.

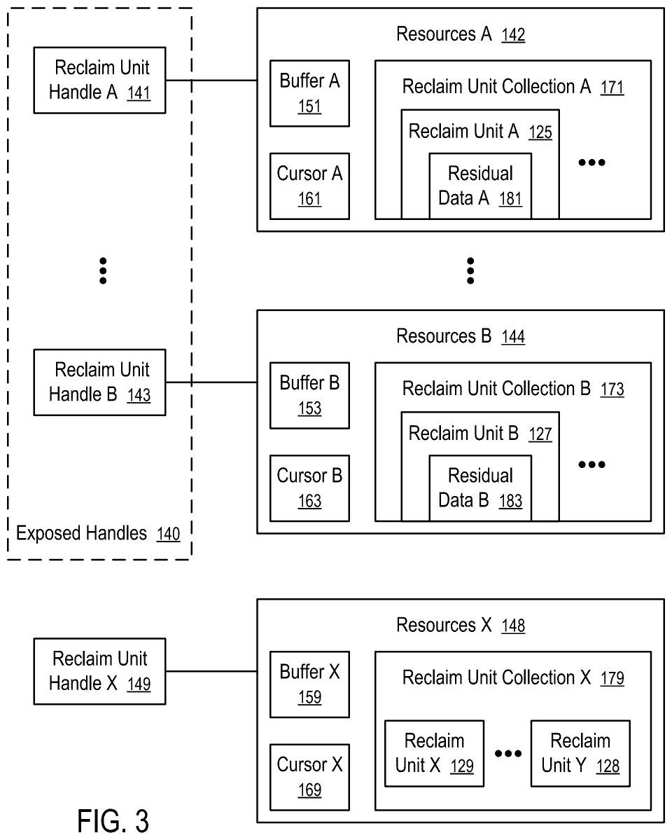

FIG. 3 shows the configuration of reclaim unit handles to implement garbage collection according to one embodiment. For example, the reclaim unit handles 141, 143, . . . , 145, and 149 of FIG. 2 can be implemented in the computing system of FIG. 1 using the configuration illustrated in FIG. 3.

In FIG. 3, each of the exposed handles 140 is configured with a separate set of resources (e.g., 142, or 144) in a memory sub-system 101 (e.g., as shown in FIG. 1).

For example, the identification of one reclaim unit handle 141 can be allocated a set of resources 142, including a buffer 151, a cursor 161, and collection 171 of reclaim units (e.g., 125, . . . ); and the identification of another reclaim unit handle 143 can be allocated a separate set of resources 144, including a buffer 153, a cursor 163, and collection 173 of reclaim units (e.g., 125, . . . ).

For example, the buffer 151 can be used by the reclaim unit handle 141 to temporarily store data to be written to a reclaim unit (e.g., 125) of the reclaim unit handle 141 before the data is programmed into the reclaim unit (e.g., 125) for persistent storage.

For example, the cursor 161 can be configured to identify where in the collection 171 of reclaim units (e.g., 125) of the reclaim unit handle 141 data can be programmed for storage for the host system 101.

In some implementations, the resources (e.g., 142) allocated to a reclaim unit handle 141 can further include processing circuits (e.g., a processor core) and/or connections to the storage resources 130 in the memory sub-system 101.

In some implementations, the resources (e.g., 142, 144) allocated to different reclaim unit handles (e.g., 141, 143) can be used in parallel in the memory sub-system 101 to program data into memory cells (e.g., 114) for execution of write commands from the host system 102.

In FIG. 3, a reclaim unit handle 149 is configured in the memory sub-system 101 but not exposed to outside of the memory sub-system 101. Thus, the host system 102 is not allowed to use the reclaim unit handle 149 to store a separate data set; and the data written via the reclaim unit handle 149 is not a data set to be separated from the data sets of the exposed handles 140.

The reclaim unit handle 149 can be reserved for garbage collection in the memory sub-system 101. The reclaim unit handle 149 can have its allocated resources 148, including a buffer 159, a cursor 169, and a collection 179 of reclaim units (e.g., 128, 129).

For example, the buffer 159 can be configured to temporarily store residual data collected from victim reclaim units (e.g., 125 or 127) before the residual data is combined and programmed into a reclaim unit (e.g., 129) in the collection 179 allocated to the reclaim unit handle 149. The cursor 169 can be configured to identify where in the collection 179 the residual data collected in the buffer 159 can be programmed for persistent storage.

In some implementations, free reclaim units (e.g., 125, 127, 128, 128) can be dynamically allocated to the reclaim unit handle 141 (e.g., just in time for their usages). When a reclaim unit (e.g., 129) is fully programmed to store data of a single reclaim unit handle (e.g., 141) among the exposed handle 141, the reclaim unit (e.g., 129) can be allocated to the reclaim unit handle (e.g., 141) for management, as if the data in the reclaim unit (e.g., 129) had been previously programmed by the reclaim unit handle 141. Thus, data placement isolation for the data sets programmed by the exposed handles 140 can persist.

In one embodiment, the garbage collection manager 113 in the memory sub-system 101 is configured to use the reclaim unit handle 149 to perform garbage collection for the exposed handles 140 one at time.

For example, when the collection 171 of the reclaim units (e.g., 125) of the reclaim unit handle 141 needs the services of garbage collection, the garbage collection manager 113 can use the reclaim unit handle 149 to aggregate and write residual data (e.g., 181) retrieved from victim reclaim units (e.g., 125) of the reclaim unit handle 141 and write the aggregated data into a reclaim unit (e.g., 129). When the reclaim unit (e.g., 129) is full, or substantially full, the reclaim unit (e.g., 129) can be moved from being allocated to the reclaim unit handle 129 to being allocated to the reclaim unit handle 141; one of the victim reclaim units (e.g., 125) erased can then be moved to being allocated to the reclaim handle 149; and the garbage collection manager 113 can move on to use the reclaim unit handle 149 to perform garbage collection for a next reclaim unit handle (e.g., 143) that needs the services of garbage collection. Thus, the reclaim units allocated to the reclaim unit handle 149 can be reduced and/or kept to a minimum.

In some situations, it can be inefficient in garbage collection when the residual data (e.g., 181, 183) of different reclaim unit handles (e.g., 141 and 143) is not aggregated into a same reclaim unit (e.g., 129). In such a situation, the garbage collection manager 113 in the memory sub-system 101 is configured to aggregate and program residual data (e.g., 181, 183) of different reclaim unit handles (e.g., 141 and 143) into a reclaim unit (e.g., 129) to maximize the reclaim units (e.g., 125 and 127) that can be erased. As a result, the reclaim unit (e.g., 129) contains data of multiple reclaim unit handles (e.g., 141 and 143) and thus isolation violations. The reclaim unit (e.g., 129) containing isolation violation cannot be reassigned to any of the exposed handles 140.

When there is an isolation violation, the memory sub-system 101 can raise a flag. In response, the garbage collection manager 113 in the host system 102 can optionally request data separation, and/or accelerate the use/invalidation of the data in the reclaim unit (e.g., 129) having isolation violation.

Optionally, when the reclaim unit 129 has isolation violations, the garbage collection manager 113 in the memory sub-system 101 can store data (e.g., in-place in the reclaim unit) identifying which portions of data stored in the reclaim unit 129 belong to which reclaim unit handles (e.g., 141, 143). During subsequent garbage collection operations, the garbage collection manager 113 in the memory sub-system 101 can prioritize the relocation of data in the reclaim unit 129 to reduce or eliminate isolation. For example, residual data stored in the reclaim unit 129 for the reclaim unit handle 141 can be received and aggregated with other residual data collected from reclaim unit collection 171 of the reclaim unit handle 141 for writing into another reclaim unit (e.g., 128) such that the residual data stored in the reclaim unit 129 for the reclaim unit handle 141 can be marked as invalid. As a result, isolation violations in the reclaim unit 129 can reduce or eliminated. When the remaining valid data in the reclaim unit 129 is for one reclaim unit handle (e.g., 143), the reclaim unit 129 has no isolation violation and thus can be reassigned to the respective reclaim unit handle (e.g., 143).

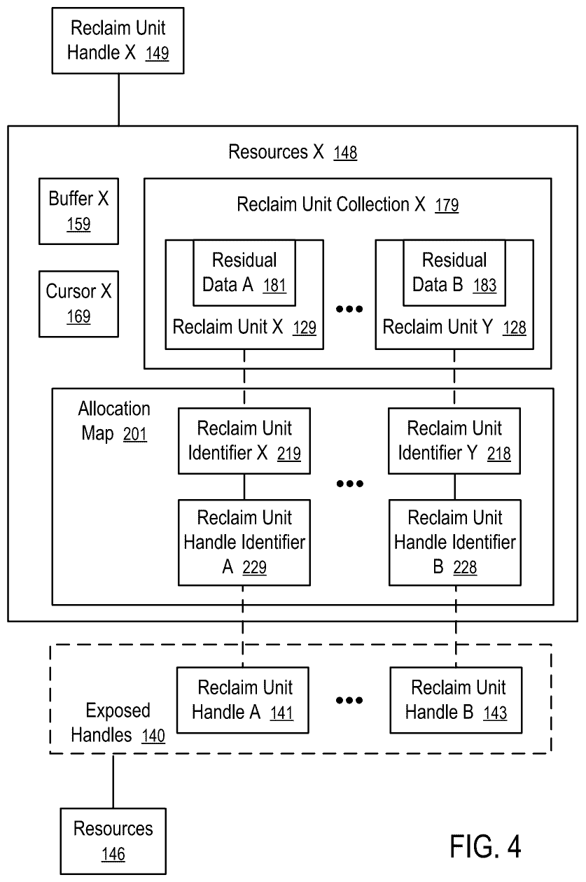

FIG. 4 to FIG. 6 show techniques to isolate data placed by different reclaim unit handles according to some embodiments. For example, the techniques of FIG. 4 to FIG. 6 can be implemented in connection with the configuration of reclaim unit handles shown in FIG. 3 in the computing system of FIG. 1.

In FIG. 4 to FIG. 6, resources 148 are configured, allocated, and/or reserved in a memory sub-system 101 for a reclaim unit handle 149 that is not exposed to outside of the memory sub-system 101.

The resources 148 can include a collection 179 of reclaim units (e.g., 129, 128) configured to store residual data collected from the reclaim units (e.g., 125, 127) allocated to exposed handles 140 during garbage collection. The resources 148 are separate from the resources 146 allocated to exposed handles 140 (e.g., reclaim unit handles 141, . . . , 143) that can be used by a host system 102 in data placement directives of write commands sent from the host system 102 to the memory sub-system 101.

To make more resources 146 available to the exposed handles 140 in servicing the write commands from the host system 102, it can be advantageous to reduce or minimize the resources 148 the resources 148 reserved for the reclaim unit handle 149 configured to write residual data collected during garbage collection. For example, the number of reclaim units (e.g., 128, 129) allocated or reserved for the reclaim unit handle 149 can be equal to or smaller than the number of exposed handles 140.

In FIG. 4, an allocation map 201 is configured to indicate which of the reclaim units (e.g., 128, 129) are used to store data of which of the exposed handles 140.

For example, the allocation map 201 can be configured to indicate that reclaim unit 129 having an identifier 219 is used to store the residual data (e.g., 181) of the reclaim unit handle 141 having an identifier 229. Storing the reclaim unit identifier 218 of the reclaim unit 128 in association with the identifier 228 of the reclaim unit handle 143 in the allocation map 201 can be used to indicate that the reclaim unit 128 is allocated to store the residual data (e.g., 183) of the reclaim unit handle 143.

The reclaim unit handle 149 can be configured to store residual data (e.g., 181, 183) collected for different exposed handles 140 to the respective reclaim units (e.g., 129, 129) according to the allocation map 201.

When a reclaim unit (e.g., 129) is full (or substantially full) as a result of garbage collection, the reclaim unit (e.g., 129) can be reallocated to the respective exposed handle (e.g., reclaim unit handle 141), as if the data in the reclaim unit (e.g., 129) were written by the exposed handle (e.g., reclaim unit handle 141) in response to write commands from the host system 102 using data placement directives identifying the reclaim unit handle 141.

When more free reclaim unit handles become available in the memory sub-system 101, some of the free reclaim unit handles can be allocated to the reclaim unit handle 149 for garbage collection. The allocation map 201 can be updated accordingly.

When there are fewer reclaim units (e.g., 128, 129) allocated to the reclaim unit handle 149 than the number of exposed handles 140, some of the exposed handles do not have a reclaim unit in the collection 179 for storing the residual data of a respective exposed reclaim unit handle (e.g., 145). As a result, the garbage collection manager 113 in the memory sub-system 101 can pause garbage collection activities specifically for the respective exposed reclaim unit handle (e.g., 145), while allowing garbage collection activities for other exposed handles 140 identified in the allocation map 201. When a reclaim unit becomes available in the collection 179 to store the residual data of the respective exposed reclaim unit handle (e.g., 145) according to the allocation map 201, the garbage collection manager 113 in the memory sub-system 101 can allow garbage collection activities for the respective exposed reclaim unit handle (e.g., 145).

In general, the number of reclaim units (e.g., 128, 129) allocated to the reclaim unit handle 149 for garbage collection can change. When the reclaim unit collection 179 shrinks to have a single reclaim unit, the garbage collection manager 113 in the memory sub-system 101 can allow garbage collection for one of the exposed handles 140 at a time without isolation violation.

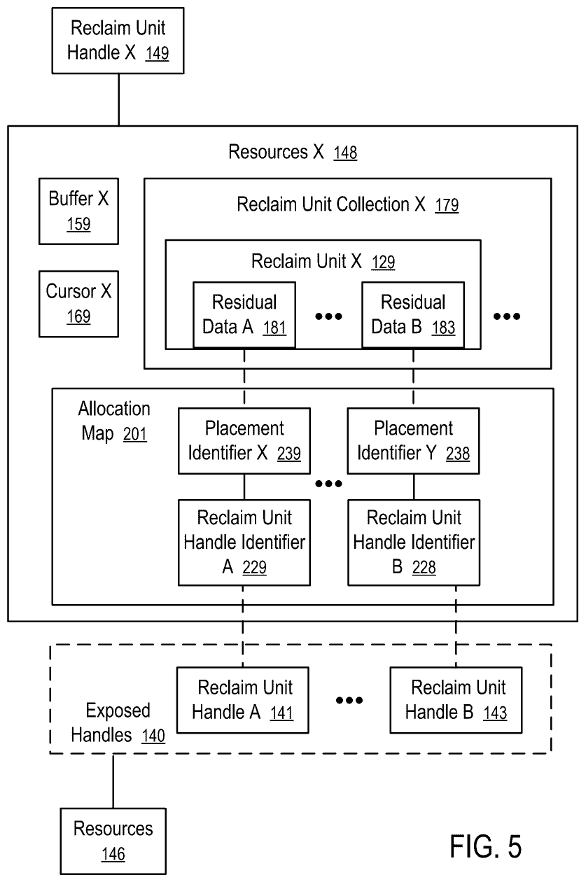

In some instances, it can be advantageous to allow isolation violations for a period of time. The allocation map 201 can be configured to indicate which portions of a reclaim unit (e.g., 129) store residual data collected for which exposed handles 140, as illustrated in FIG. 5.

In FIG. 5, the reclaim unit 129 has one portion allocated to store residual data 181 of an expose reclaim unit handle 141, and another portion allocated to store residual data 183 of another exposed reclaim unit handle 143. For example, the placement identifier 239 in the allocation map 201 can be configured to identify the reclaim unit 129 and a particular portion of the reclaim unit 129 that stores the residual data 181 of a reclaim unit handle 141 having the identifier 229. Similarly, the placement identifier 238 in the allocation map 201 can be configured to identify the reclaim unit 129 and a separate portion of the reclaim unit 129 that stores the residual data 183 of another reclaim unit handle 143 having the identifier 228.

When the residual data of multiple exposed reclaim unit handles (e.g., 141 and 143) is stored in the reclaim unit 129, the reclaim unit 129 has isolation violation. In response, the memory sub-system 101 can raise a flag to indicate the presence of isolation violation. In response to the flag, the garbage collection manager 113 in the host system 102 can optionally request the memory sub-system 101 to remove isolation violation, or to perform operations to accelerate the invalidation of the data in the reclaim unit 129 having isolation violation.

When a free reclaim unit (e.g., 128) is added to the resources 146 for the reclaim unit handle 149 and allocated, via the map 201, to store the residual data of reclaim unit handle 143 (e.g., as in FIG. 4), the garbage collection manager 113 in the memory sub-system 101 can retrieve residual data (e.g., 183) of the reclaim unit handle 143 from reclaim units (e.g., 129) having isolation violation, store the retrieved residual data (e.g., 183) to the added reclaim unit (e.g., 128), and mark the corresponding data in the reclaim unit (e.g., 129) as invalid, which can reduce or eliminate isolation violation. When there is no more isolation violation, the flag can be cleared.

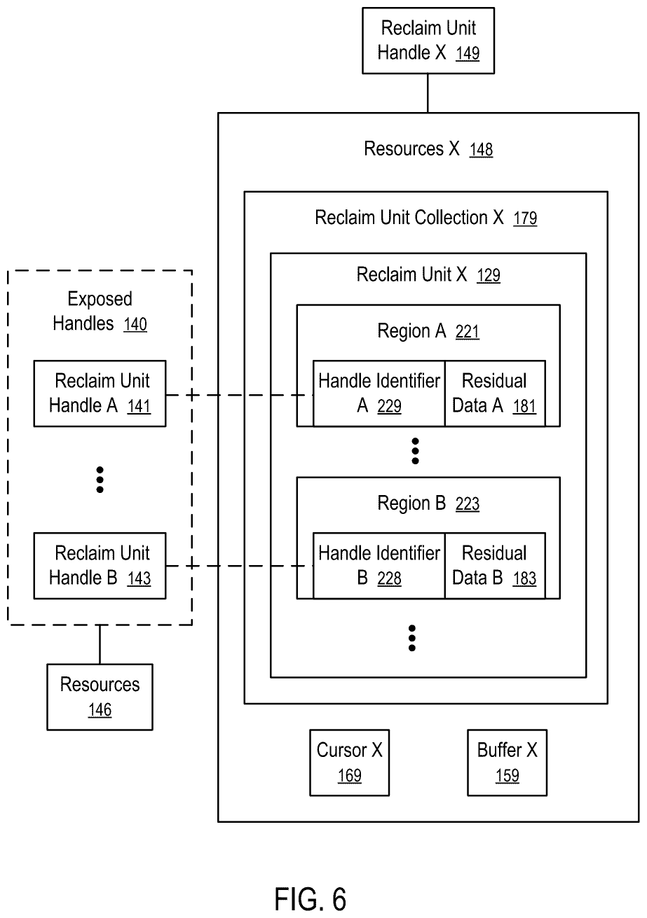

Optionally, the data of the allocation map 201 can be stored in place in the reclaim units (e.g., 129, 128) that store the residual data (e.g., 181, 183) collected during garbage collection, as illustrated in FIG. 6.

FIG. 6 illustrates an example where reclaim unit 129 is used to store residual data 181 of the exposed reclaim unit handle 141 in region 221, and residual data 183 of the exposed reclaim unit handle 143. Tags of handle identifiers 229 and 228 can be stored in the regions 221 and 223 to indicate that the corresponding residual data 181 and 183 in the regions belong to the reclaim unit handles 141 and 143 respectively. The tags allow the garbage collection manager 113 to separate the placement of residual data 181 and 183 to remove or reduce isolation violation (e.g., during a time period where the workload from the host system 101 is low).

FIG. 6 shows the storing of handle identifiers (e.g., 229, 228) in respective regions (e.g., 221, 223) in which the residual data (e.g., 181, 183) is stored. Alternatively, the data of the allocation map 201 can be stored in a predefined region (e.g., a predefined page of memory cells) in the reclaim unit 129. Optionally, the allocation map 201 can be stored in a portion of the buffer 159 as the meta data of the residual data stored in the collection 179 of reclaim units (e.g., 129) allocated to the reclaim unit handle 149.

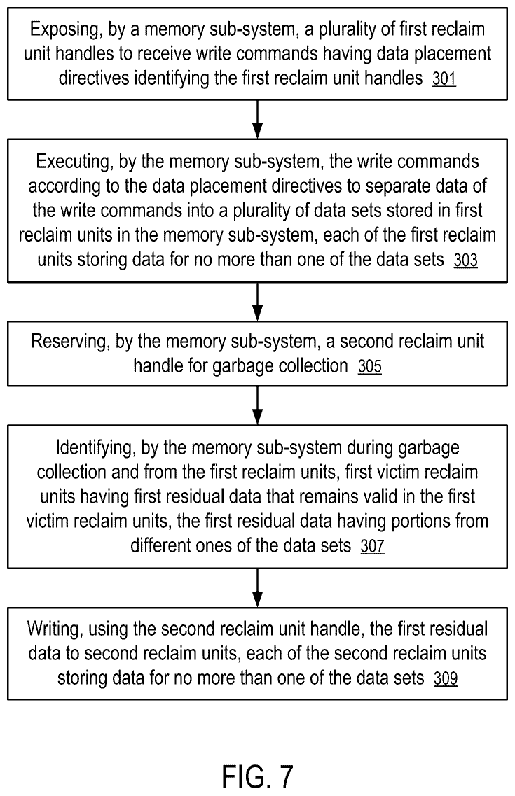

FIG. 7 shows a method of garbage collection according to one embodiment. The method of FIG. 7 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 7 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 7 can be implemented using the garbage collection managers 113 of FIG. 1 to perform the operations discussed above in connection with FIG. 2 to FIG. 6.

For example, the storage resources 130 of the memory sub-system 101 can be grouped/organized in the form of reclaim units 125, 127, . . . , 129. The host system 102 can specify exposed handles 140 in data placement directives of write commands to instruct the memory sub-system 101 to place data of the write commands into separate sets of reclaim units (e.g., collections 171, . . . , 173). Each of the sets of reclaim units associated with one exposed reclaim unit handle (e.g., 141 or 143) (e.g., reclaim unit collection 171) is configured to store a single set of data written to the memory sub-system 101 via the use of the corresponding reclaim unit handle (e.g., 141 or 143). Thus, without garbage collection, the data sets are physically isolated from each other in the separate reclaim unit collections (e.g., 171, . . . , 173) allocated to the reclaim unit handles (e.g., 141, . . . , 143) respectively.

At block 301, the method of FIG. 7 includes exposing, by the memory sub-system 101, a plurality of first reclaim unit handles 141, 143, . . . , 145 to receive, from outside of the memory sub-system 101, write commands having data placement directives identifying the first reclaim unit handles 141, 143, . . . , 145.

At block 303, the method includes executing, by the memory sub-system 101, the write commands according to the data placement directives to separate data of the write commands into a plurality of data sets that are stored in first reclaim units (e.g., 125, 127) in the memory sub-system 101. Each of the first reclaim units (e.g., 125, 127) stores data for no more than one of the data sets, and is associated with only one of the first reclaim unit handles 141, 143, . . . , 145.

At block 305, the method includes reserving, by the memory sub-system 101, a second reclaim unit handle 149 for garbage collection.

For example, the second reclaim unit handle 149 is reserved for internal use by the memory sub-system 101 and thus is usable in a write command from outside of the memory sub-system 101 to specify data placement for the write command.

At block 307, the method includes identifying, by the memory sub-system during garbage collection and from the first reclaim units (e.g., 125, 127), first victim reclaim units (e.g., 125, 127) having first residual data (e.g., 181, 183) that remains valid in the first victim reclaim units (e.g., 125, 127). The first residual data can have portions (e.g., residual data 181, 183) that are from different ones of the data sets associated with the exposed handles 140 respectively.

At block 309, the method includes writing, using the second reclaim unit handle 149, the first residual data (e.g., 181, 183) to second reclaim units (e.g., 129, 128 as in FIG. 4) such that each of the second reclaim units (e.g., 129, 128) storing data for no more than one of the data sets.

In some implementations, the garbage collection manager 113 in the memory sub-system 101 can always separate residual data collected during garbage collection into different reclaim units such that none of the reclaim units stores residual data for more than one data set. Thus, the isolation of data placement as configured via the use the exposed handles 140 can persist through garbage collection.

In other implementations, the garbage collection manager 113 in the memory sub-system 101 is configured to implement isolation of data placement under some conditions (e.g., when the reclaim unit handle 149 has sufficient resources to handle the requests to store residual data without extended delay). Under other conditions, the garbage collection manager 113 in the memory sub-system 101 can mix the residual data from different data sets in a same reclaim unit (e.g., 129 in FIG. 5 and FIG. 6) so that there is an isolation violation.

For example, the writing of the first residual data to the second reclaim units at block 309 can be in response to garbage collection in a first condition; and the method can further include writing of the second residual data to a third reclaim unit is in response to garbage collection in a second condition.

For example, the method can further include: identifying, by the memory sub-system 101 during garbage collection and from the first reclaim units (e.g., 125, 127), second victim reclaim units (e.g., 125, 127) having second residual data (e.g., 181, 183) that remains valid in the second victim reclaim units (e.g., 125, 127). The second residual data can have portions (e.g., residual data 181, 183) from different ones of the data sets associated with the respective exposed reclaim unit handles (e.g., 141, 143); and writing, using the second reclaim unit handle (e.g., 149), the second residual data to a third reclaim unit (e.g., 129, as in FIG. 5 and FIG. 6). Writing the second residual data collected from more than one data set to the third reclaim unit (e.g., 129, as in FIG. 5 and FIG. 6) causes isolation violations. Thus, the method can optionally further include: raising a flag indicative of isolation violation in response to writing the second residual data to the third reclaim unit (e.g., 129, as in FIG. 5 and FIG. 6).

Optionally, the method can further include: storing an allocation map 201 (e.g., as in FIG. 4 to FIG. 6). For example, the allocation map 201 can be configured to identify data set origins of portions of the second residual data written to the third reclaim unit.

Optionally, the method can further include: retrieving, according to the allocation map 201, a first portion of the second residual data (e.g., 183) from the third reclaim unit 129; writing, using the second reclaim unit handle 149, the first portion of the second residual data (e.g., 183) to a fourth reclaim unit (e.g., 128); and marking the first portion of the second residual data as invalid in the third reclaim unit (e.g., 129) to reduce a number of data sets for which the third reclaim unit (e.g., 129) stores valid data.

After the number of data sets for which the third reclaim unit (e.g., 129) stores valid data becomes smaller than two, there can be no more isolation violation. In response, the memory sub-system 101 can clear the flag previously raised to indicate the presence of isolation violation.

A non-transitory computer storage medium can be used to store instructions programmed to implement the garbage collection managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

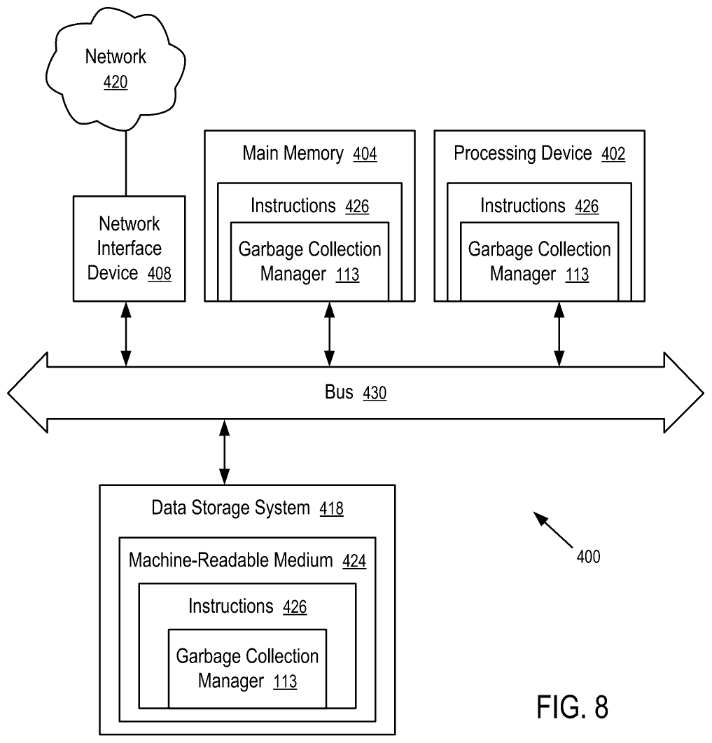

FIG. 8 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of garbage collection managers 113 (e.g., to execute instructions to perform operations corresponding to the garbage collection managers 113 described with reference to FIGS. 1-7). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the garbage collection managers 113 described with reference to FIGS. 1-7. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
exposing, by a memory sub-system, a plurality of first reclaim unit handles to receive write commands having data placement directives identifying the first reclaim unit handles;
executing, by the memory sub-system, the write commands according to the data placement directives to separate data of the write commands into a plurality of data sets stored in first reclaim units in the memory sub-system, each of the first reclaim units storing data for no more than one of the data sets;
reserving, by the memory sub-system, a second reclaim unit handle for garbage collection;
identifying, by the memory sub-system during garbage collection and from the first reclaim units, first victim reclaim units having first residual data that remains valid in the first victim reclaim units, the first residual data having portions from different ones of the data sets; and
writing, using the second reclaim unit handle, the first residual data to second reclaim units, each of the second reclaim units storing data for no more than one of the data sets.

2. The method of claim 1, wherein the second reclaim unit handle is not usable in a write command from outside of the memory sub-system to specify data placement for the write command.

3. The method of claim 2, further comprising:
identifying, by the memory sub-system during garbage collection and from the first reclaim units, second victim reclaim units having second residual data that remains valid in the second victim reclaim units, the second residual data having portions from different ones of the data sets; and
writing, using the second reclaim unit handle, the second residual data to a third reclaim unit.

4. The method of claim 3, further comprising:
raising a flag indicative of isolation violation in response to writing the second residual data to the third reclaim unit.

5. The method of claim 4, further comprising:
storing an allocation map configured to identify data set origins of portions of the second residual data written to the third reclaim unit.

6. The method of claim 5, further comprising:
retrieving, according to the allocation map, a first portion of the second residual data from the third reclaim unit;
writing, using the second reclaim unit handle, the first portion of the second residual data to a fourth reclaim unit; and
marking the first portion of the second residual data as invalid in the third reclaim unit to reduce a number of data sets for which the third reclaim unit stores valid data.

7. The method of claim 6, further comprising:
clearing, after the number of data sets for which the third reclaim unit stores valid data becomes smaller than two, the flag.

8. The method of claim 7, wherein the writing of the first residual data to the second reclaim units is in response to garbage collection in a first condition; and the writing of the second residual data to the third reclaim unit is in response to garbage collection in a second condition.

9. A memory sub-system, comprising:
non-volatile memory cells configured as a plurality of reclaim units; and
a controller configured to:
expose a plurality of first reclaim unit handles to receive write commands having data placement directives identifying the first reclaim unit handles;
execute the write commands according to the data placement directives to separate data of the write commands into a plurality of data sets stored in first reclaim units in the memory sub-system, each of the first reclaim units storing data for no more than one of the data sets;
reserve a second reclaim unit handle for garbage collection, wherein the second reclaim unit handle is not usable in a write command from outside of the memory sub-system to specify data placement for the write command;
identify, during garbage collection and from the first reclaim units, first victim reclaim units having first residual data that remains valid in the first victim reclaim units, the first residual data having portions from different ones of the data sets; and
write, using the second reclaim unit handle, the first residual data to second reclaim units, each of the second reclaim units storing data for no more than one of the data sets.

10. The memory sub-system of claim 9, wherein the controller is further configured to:
identify, during garbage collection and from the first reclaim units, second victim reclaim units having second residual data that remains valid in the second victim reclaim units, the second residual data having portions from different ones of the data sets; and
writing, using the second reclaim unit handle, the second residual data to a third reclaim unit.

11. The memory sub-system of claim 10, wherein the controller is further configured to:
raise a flag indicative of isolation violation in response to writing the second residual data to the third reclaim unit.

12. The memory sub-system of claim 11, wherein the controller is further configured to:
store an allocation map configured to identify data set origins of portions of the second residual data written to the third reclaim unit.

13. The memory sub-system of claim 12, wherein the controller is further configured to:
retrieve, according to the allocation map, a first portion of the second residual data from the third reclaim unit;
write, using the second reclaim unit handle, the first portion of the second residual data to a fourth reclaim unit; and
mark the first portion of the second residual data as invalid in the third reclaim unit to reduce a number of data sets for which the third reclaim unit stores valid data.

14. The memory sub-system of claim 13, wherein the controller is further configured to:
clear, after the number of data sets for which the third reclaim unit stores valid data becomes smaller than two, the flag.

15. The memory sub-system of claim 14, wherein the controller is configured to write the first residual data to the second reclaim units in response to garbage collection in a first condition, and to write the second residual data to the third reclaim unit in response to garbage collection in a second condition.

16. A non-transitory computer storage medium storing instructions which, when executed in a memory sub-system, cause the memory sub-system to perform a method, comprising:
exposing, by the memory sub-system, a plurality of first reclaim unit handles to receive write commands having data placement directives identifying the first reclaim unit handles;
executing, by the memory sub-system, the write commands according to the data placement directives to separate data of the write commands into a plurality of data sets stored in first reclaim units in the memory sub-system, each of the first reclaim units storing data for no more than one of the data sets;
reserving, by the memory sub-system, a second reclaim unit handle for garbage collection;
identifying, by the memory sub-system during garbage collection and from the first reclaim units, first victim reclaim units having first residual data that remains valid in the first victim reclaim units, the first residual data having portions from different ones of the data sets;
writing, using the second reclaim unit handle and under a first condition, the first residual data to second reclaim units, each of the second reclaim units storing data for no more than one of the data sets;
identifying, by the memory sub-system during garbage collection and from the first reclaim units, second victim reclaim units having second residual data that remains valid in the second victim reclaim units, the second residual data having portions from different ones of the data sets; and
writing, using the second reclaim unit handle and under a second condition, the second residual data to a third reclaim unit.

17. The non-transitory computer storage medium of claim 16, wherein the method further comprises:
raising a flag indicative of isolation violation in response to writing the second residual data to the third reclaim unit.

18. The non-transitory computer storage medium of claim 17, wherein the method further comprises:
storing an allocation map configured to identify data set origins of portions of the second residual data written to the third reclaim unit.

19. The non-transitory computer storage medium of claim 18, wherein the method further comprises:
retrieving, according to the allocation map, a first portion of the second residual data from the third reclaim unit;
writing, using the second reclaim unit handle, the first portion of the second residual data to a fourth reclaim unit; and
marking the first portion of the second residual data as invalid in the third reclaim unit to reduce a number of data sets for which the third reclaim unit stores valid data.

20. The non-transitory computer storage medium of claim 19, wherein the method further comprises:
clearing, after the number of data sets for which the third reclaim unit stores valid data becomes smaller than two, the flag.
